(19) United States
(12) Patent Application Publication
(10) Pub. No.: US 2013/0154973 A1
(43) Pub. Date: Jun. 20, 2013

(54) TOUCH PAD WITH FEEDBACK FUNCTION AND TOUCH DEVICE USING THE SAME

(71) Applicant: Industrial Technology Research Institute, Hsinchu (TW)

(72) Inventors: Mean-Jue Tung, Kinmen County (TW); Wen-Song Ko, Hsinchu City (TW); Yu-Ting Huang, Hsinchu County (TW); Ming-Da Yang, Taichung City (TW)

(73) Assignee: INDUSTRIAL TECHNOLOGY RESEARCH INSTITUTE, Hsinchu (TW)

(21) Appl. No.: 13/710,465

(22) Filed: Dec. 11, 2012

(30) Foreign Application Priority Data
Dec. 20, 2011 (TW) 100147455

(51) Int. Cl. G06F 3/041

(52) U.S. Cl. CPC G06F 3/041
USPC 345/173

(57) ABSTRACT

A touch pad with a feedback function and a touch device using the same are provided. The provided touch pad includes a touch sensing film layer and a vibration film layer, where the vibration film layer is disposed above the touch sensing film layer and includes a permanent charge layer. Moreover, the vibration film layer is configured for generating vibration in response to a touch event on the touch sensing film layer.

### CROSS-REFERENCE TO RELATED APPLICATION

This application claims the priority benefit of Taiwan application serial no. 100147455, filed on Dec. 20, 2011. The entirety of the above-mentioned patent application is hereby incorporated by reference herein and made a part of this specification.

### TECHNICAL FIELD

The technical field relates to a touch pad with feedback function and a touch device using the same.

### BACKGROUND

As the electronic technology is developed and used more and more widely, life rely on the electronic product is also increasing day by day, and various input devices (such as a keyboard, a mouse, a touch device and trackball) are used to input data or operate the electronic product. The touch device has a small dimension and may be operated easily in small space, and therefore, it is widely integrated in electronic products such as a notebook, a personal digital assistant (PDA) and a mobile phone.

However, the most current touch pads on the market are used to convert the external touches into the position signals for outputting, and thus, the most current touch pads are substantially to be served as input devices/interfaces only. Compare with the conventional tangible keyboard, the touch pad does not have the feedback capability in response to the user's touch. That is, when a user operates the touch pad, he or she does not get any elastic tactility or the acoustical feedback as operating the tangible keyboard.

### SUMMARY

An exemplary embodiment of the disclosure provides a touch pad with a feedback function, which includes a touch sensing film layer and a vibration film layer. The vibration film layer is disposed (or stacked) above (or with) the touch sensing film layer and includes a permanent charge layer. The vibration film layer is configured for generating vibration in response to a touch event on the touch sensing film layer.

An exemplary embodiment of the disclosure provides a touch device including a display module and a touch pad with a feedback function. The display module is configured to be served as a display interface of the touch device. The touch pad with the feedback function similarly includes a touch sensing film layer and a vibration film layer. The touch sensing film layer is disposed above the display module, and configured to be served as an input interface of the touch device. The vibration film layer is disposed above the touch sensing film layer and includes a permanent charge layer. The vibration film layer is configured for generating vibration in response to a touch event on the touch sensing film layer.

An exemplary embodiment of the disclosure provides a vibration film layer suitable for a touch pad. The vibration film layer includes a first electrode layer, a spacer layer, a permanent charge layer and a second electrode layer. The first electrode layer is disposed above a touch sensing film layer of the touch pad. The spacer layer is disposed above the first electrode layer. The permanent charge layer is disposed above the spacer layer. The second electrode layer is disposed above the permanent charge layer. The first and the second electrode layers coordinate with the permanent charge layer to generate vibration in response to a touch event on the touch sensing film layer.

### BRIEF DESCRIPTION OF THE DRAWINGS

The accompanying drawings are included to provide a further understanding of the embodiments of invention, and are incorporated in and constitute a part of this specification. The drawings illustrate embodiments of the invention and, together with the description, serve to explain the principles of the invention.

FIG. 1 is a system diagram of a touch device according to an exemplary embodiment of the disclosure.

FIG. 2 is an implement diagram of a touch pad according to an exemplary embodiment of the disclosure.

FIG. 3 is a diagram of a vibration film layer having a plurality of patterned electrodes according to an exemplary embodiment of the disclosure.

FIG. 4 is an implement diagram of a touch pad according to another exemplary embodiment of the disclosure.

FIG. 5 is an implement diagram of a touch pad according to further exemplary embodiment of the disclosure.

### DETAIL DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

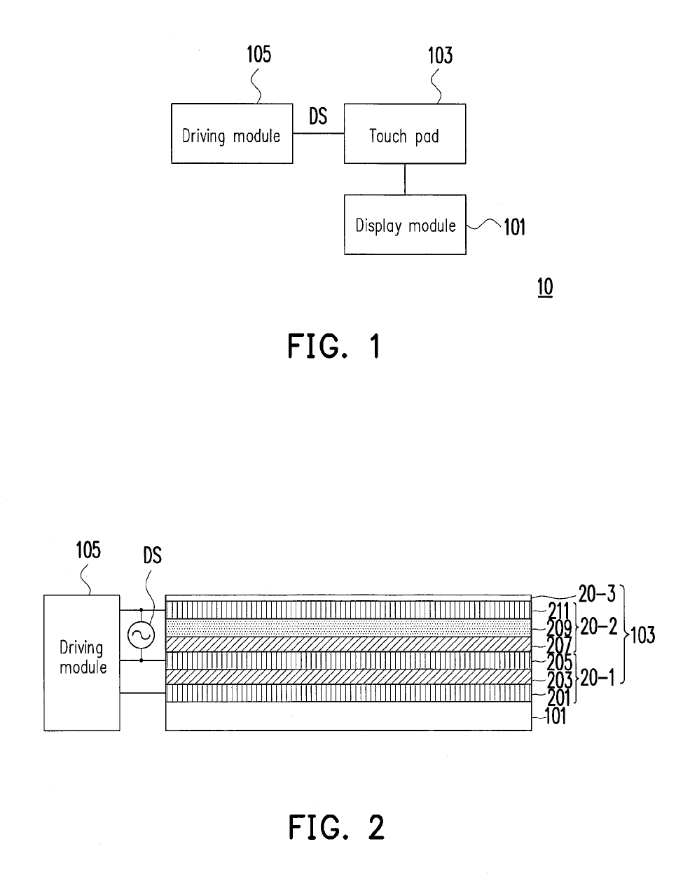

FIG. 1 is a system diagram of a touch device 10 according to an exemplary embodiment of the disclosure. Referring to FIG. 1, the touch device 10 includes a display module 101, a touch pad 103 with a feedback function, and a driving module 105. The display module 101 may be a liquid crystal display module (LCM) or an organic light-emitting diode (OLED) display module, but not limited thereto, and the display module 101 is configured to be served as a display interface of the touch device 10.

In addition, the touch pad 103 is disposed above the display module 101, and configured to be served as an input interface of the touch device 10. Furthermore, the driving module 105 is coupled to the touch pad 103. The driving module 105 is configured to analyze the touch positions of the touch events occurred on the touch pad 103, and accordingly generate at least one driving signal DS to drive the touch pad 103, such that the touch pad 103 may generate vibration feedback in response to the touch event(s) on the touch pad 103.

To be specific, FIG. 2 is an implement diagram of the touch pad 103 according to an exemplary embodiment of the disclosure. Referring to FIGS. 1 and 2, the touch pad 103 with the feedback function includes a touch sensing film layer 20-1, a vibration film layer 20-2 and a hard coat layer 20-3. The touch sensing film layer 20-1 is disposed above the display module 101, and configured to be served as the input interface of the touch device 10. In addition, the vibration film layer 20-2 is disposed above the touch sensing film layer 20-1, and configured to generate vibration in response to the touch event(s) on the touch sensing film layer 20-1. Furthermore, the hard coat layer 20-3 is disposed above the vibration film layer 20-2.

In this exemplary embodiment, the touch sensing film layer 20-1 includes an electrode layer 201, a spacer layer 203 and a common electrode layer 205. The electrode layer 201 is disposed above the display module 101. The spacer layer 203 is disposed above the electrode layer 201. The common electrode layer 205 is disposed above the spacer layer 203. The electrode layer 201 and the common electrode layer 205 form a touch sensing module so as to sense the touch event(s) on the touch sensing film layer 20-1. It is noted that the touch sensing module formed by the electrode layer 201 and the common electrode layer 205 may be a resistive touch sensing module or a capacitive touch sensing module, but not limited thereto.

On the other hand, the vibration film layer 20-2 includes a spacer layer 207, a permanent charge layer 209 and an electrode layer 211. The spacer layer 207 is disposed above the common electrode layer 205 and disposed under the permanent charge layer 209. In other words, the permanent charge layer 209 is disposed above the spacer layer 207. The electrode layer 211 is disposed above the permanent charge layer 209. The electrode layer 211 and the common electrode layer 205 are driven by the driving signal DS, from the driving module 105, generated in response to the touch event(s) occurred on the touch sensing film layer 20-1, such that the electrode layer 211 and the common electrode layer 205 coordinate with the permanent charge layer 209 to generate the vibration feedback corresponding to the occurred touch event(s).

In this exemplary embodiment, the material of the permanent charge layer 209 is the electret material, and the electret material may be fabricated/manufactured by organic materials (for example, paraffin, hard rubber, hydro-carbon, solid acid, etc.) or inorganic materials (for example, barium titanate, calcium titanate, etc.), but not limited thereto.

In addition, the common electrode layer 205 may be a ground layer, and the electrode layers 201 and 211 may be signal layers. In this case, the driving module 105 is coupled to the electrode layers 201, 211 and the common electrode layer 205, and configured to generate the driving signal DS in response to touch event(s) occurred on the touch sensing film layer 20-1. To be specific, the driving module 105 can analyze the touch position(s) of the touch event(s) occurred on the touch sensing film layer 20-1, such that the driving module 105 can generate the driving signal DS according to the analyzed result to drive the vibration film layer 20-2, and thus making the vibration film layer 20-2 generate vibration feedback corresponding to the occurred touch event(s).

It is also noted that after the vibration film layer 20-2 is driven by the driving signal DS generated from the driving module 105, by adjusting the frequency of the driving signal DS generated from the driving module 105 within the range of the audio frequency (20 Hz-20 kHz, but not limited thereto), the vibration film layer 20-2 is not only to generate vibration feedback corresponding to the occurred touch event(s), but also to simultaneously generate sound feedback corresponding to the occurred touch event(s). In other words, the electrode layer 211 and the common electrode layer 205 are driven by the driving signal DS, from the driving module 105, generated in response to the touch event(s) occurred on the touch sensing film layer 20-1, such that the electrode layer 211 and the common electrode layer 205 may further coordinate with the permanent charge layer 209 to generate the sound feedback corresponding to the occurred touch event(s).

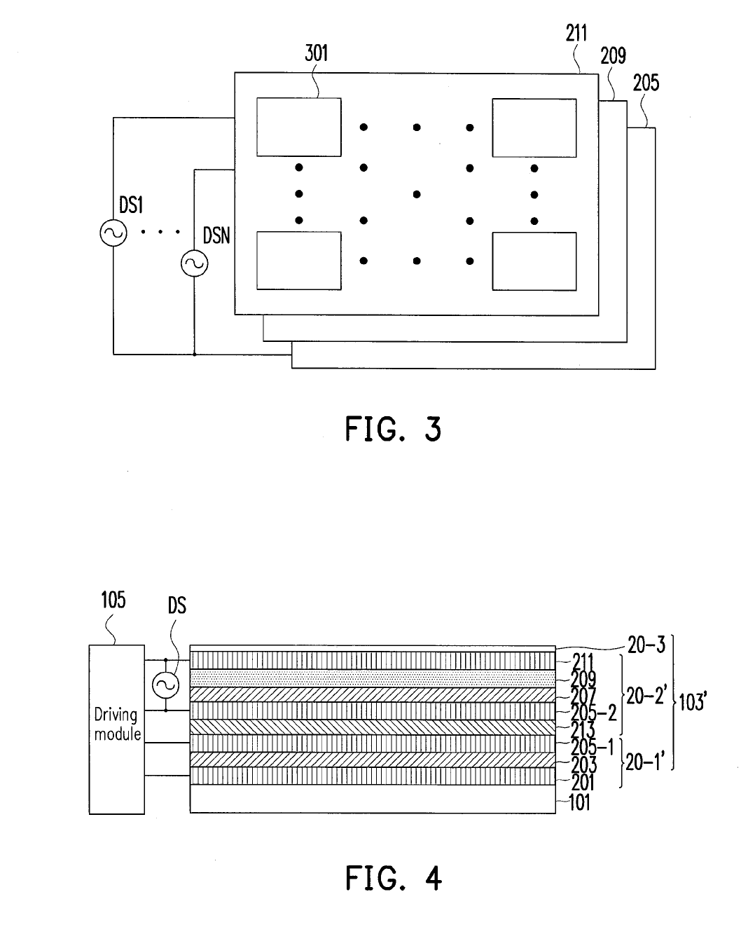

On the other hand, in another exemplary embodiment, a plurality of patterned electrodes may be designed on the electrode layer 211, for example, N rectangle electrodes 301 arranged in an array, as shown in FIG. 3, but not limited thereto, so as to achieve the purpose of vibration feedback relating to multi-touch. In this case, the driving module 105 may generate N driving signals DS1-DSN with different frequencies and/or amplitudes and/or waveforms in response to N different touch events on the touch sensing film layer 20-1. Accordingly, the N patterned (rectangle) electrodes 301 on the electrode layer 211 can coordinate with the common electrode layer 205 and the permanent charge layer 209 to respectively generate different vibration feedbacks in response to the N different driving signals DS1-DSN generated by the driving module 105. It is noted that, by changing the frequencies and/or amplitudes and/or waveforms of the driving signals DS1-DSN respectively corresponding to the N patterned (rectangle) electrodes 301, not only to achieve the purpose of vibration feedback relating to multi-touch, but also to achieve the purpose of vibration feedback with different levels.

Similarly, by adjusting the frequencies of the driving signals DS1-DSN generated from the driving module 105 within the range of the audio frequency, the vibration film layer 20-2 is not only to generate vibration feedback corresponding to the occurred touch event(s), but also to simultaneously generate sound feedback corresponding to the occurred touch event(s). In other words, the electrode layer 211 having a plurality of patterned (rectangle) electrodes 301 and the common electrode layer 205 are driven by the driving signals DS1-DSN, from the driving module 105, generated in response to the touch event(s) occurred on the touch sensing film layer 20-1, such that the electrode layer 211 having a plurality of patterned (rectangle) electrodes 301 and the common electrode layer 205 may further coordinate with the permanent charge layer 209 to generate the sound feedback corresponding to the occurred touch event(s), and even to generate the sound feedback with different levels.

Compare with the above exemplary embodiments, FIG. 4 is an implement diagram of a touch pad 103′ according to another exemplary embodiment of the disclosure. Referring to FIGS. 2 and 4, the touch pad 103′ as shown in FIG. 4 also includes a touch sensing film layer 20-1′, a vibration film layer 20-2′ and a hard coat layer 20-3. Compare with FIG. 2, the touch sensing film layer 20-1′ and the vibration film layer 20-2′ have the respective ground layers independently rather than have a common ground layer (i.e. the common electrode layer 205).

To be specific, the touch sensing film layer 20-1′ includes an electrode layer 201, a spacer layer 203 and an electrode layer 205-1. The electrode layer 201 is disposed above the display module 101. The spacer layer 203 is disposed above the electrode layer 201. The electrode layer 205-1 is disposed above the spacer layer 203. Similarly, the electrode layers 201 and 205-1 may form a touch sensing module which may be a resistive or a capacitive touch sensing module, but not limited thereto, so as to sense the touch event(s) on the touch sensing film layer 20-1′.

On the other hand, the vibration film layer 20-2′ includes an electrode layer 205-2, a spacer layer 207, a permanent charge layer 209, an electrode layer 211 and a (transparent) isolation layer 213. The isolation layer 213 is disposed above the electrode layer 205-1. The electrode layer 205-2 is disposed above the isolation layer 213. The spacer layer 207 is disposed above the electrode layer 205-2 and disposed under the permanent charge layer 209. In other words, the permanent charge layer 209 is disposed above the spacer layer 207. The electrode layer 211 is disposed above the permanent charge layer 209 and disposed under the hard coat layer 20-3. In other words, the hard coat layer 20-3 is disposed above the electrode layer 211. Similarly, the electrode layer 211 and the electrode layer 205-2 are driven by the driving signal DS, from the driving module 105, generated in response to the touch event(s) occurred on the touch sensing film layer 20-1′, such that the electrode layer 211 and the electrode layer 205-2 coordinate with the permanent charge layer 209 to generate the vibration feedback corresponding to the occurred touch event(s).

In this exemplary embodiment, one of the electrode layers 201, 205-1 and one of the electrode layers 205-2, 211 are ground layers, and the other of the electrode layers 201, 205-1 and the other of the electrode layers 205-2, 211 are signal layers. For example, if the electrode layers 201, 211 are signal layers, the electrode layers 205-1, 205-2 are ground layers, and vice versa. In this case, the driving module 105 is coupled to the electrode layers 201, 211, 205-1 and 205-2, and configured to generate the driving signal DS in response to touch event(s) occurred on the touch sensing film layer 20-1′ to drive the vibration film layer 20-2′. Herein, the manners of that the driving module 105 analyzes the touch event(s) occurred on the touch sensing film layer 20-1′, and drives the vibration film layer 20-2′ are similar to the above exemplary embodiments, so the detail descriptions thereto are omitted.

Similarly, by adjusting the frequency of the driving signal DS generated from the driving module 105 within the range of the audio frequency, the vibration film layer 20-2′ is not only to generate vibration feedback corresponding to the occurred touch event(s), but also to simultaneously generate sound feedback corresponding to the occurred touch event(s). On the other hand, in another exemplary embodiment, a plurality of patterned electrodes may also be designed on the electrode layer 211, for example, N rectangle electrodes 301 arranged in an array, as shown in FIG. 3, but not limited thereto, so as to achieve the purpose of vibration feedback relating to multi-touch as the above exemplary embodiment, and achieve the purpose of vibration/sound feedback with different levels, such that the detail descriptions thereto are also omitted.

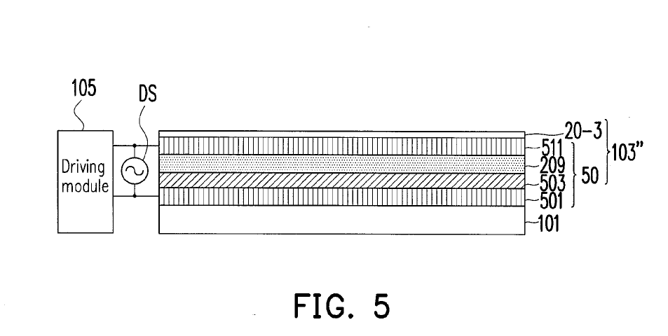

Different from the above exemplary embodiments, FIG. 5 is an implement diagram of a touch pad 103″ according to further exemplary embodiment of the disclosure. Referring to FIGS. 2 and 5, the touch pad 103″ as shown in FIG. 5 includes a composite film layer 50 and a hard coat layer 20-3, wherein the composite film layer 50 is formed by integrating the touch sensing film layer 20-1 with the vibration film layer 20-2 both shown in FIG. 2. Compare with FIG. 2, the composite film layer 50 has a common ground layer, a common signal layer and a common spacer layer.

To be specific, the composite film layer 50 includes a common electrode layer 501, a common spacer layer 503, a permanent charge layer 209 and a common electrode layer 511. The common electrode layer 501 is disposed above the display module 101. The common spacer layer 503 is disposed above the common electrode layer 501 and disposed under the permanent charge layer 209. In other words, the permanent charge layer 209 is disposed above the common spacer layer 503. The common electrode layer 511 is disposed above the permanent charge layer 209 and disposed under the hard coat layer 20-3. In other words, the hard coat layer 20-3 is disposed above the common electrode layer 511. The common electrode layers 501 and 511 form a touch sensing module which may be a resistive or a capacitive touch sensing module, but not limited thereto, so as to sense the touch event(s) on the composite film layer 50, moreover, the common electrode layers 501 and 511 are driven by the driving signal DS, from the driving module 105, generated in response to the touch event(s) occurred on the composite film layer 50, such that the common electrode layers 501 and 511 coordinate with the permanent charge layer 209 to generate the vibration feedback corresponding to the occurred touch event(s).

In this exemplary embodiment, the common electrode layer 501 may be a ground layer, and the common electrode layer 511 may be a signal layer. In this case, the driving module 105 is coupled to the common electrode layers 501 and 511, and configured to generate the driving signal DS in response to touch event(s) occurred on the composite film layer 50 to drive the composite film layer 50. Herein, the manners of that the driving module 105 analyzes the touch event(s) occurred on the composite film layer 50, and drives the composite film layer 50 are similar to the above exemplary embodiments, so the detail descriptions thereto are omitted.

It is noted that due to the common signal layer (511) and the common ground layer (501), in order to avoid that the vibration feedback generated by driving the composite film layer 50 is affected while the touch position(s) of the touch event(s) occurred on the composite film layer 50 is/are analyzed, or avoid that the analysis of the touch position(s) of the touch event(s) occurred on the composite film layer 50 is affected while the vibration feedback is generated by driving the composite film layer 50, an insulation should be performed between the common signal layer (511) and the common ground layer (501), so as to avoid the interference between the analysis of the composite film layer 50 and the driving of the composite film layer 50.

Similarly, by adjusting the frequency of the driving signal DS generated from the driving module 105 within the range of the audio frequency, the composite film layer 50 is not only to generate vibration feedback corresponding to the occurred touch event(s), but also to simultaneously generate sound feedback corresponding to the occurred touch event(s). On the other hand, in another exemplary embodiment, a plurality of patterned electrodes may also be designed on the common electrode layer 511, for example, N rectangle electrodes 301 arranged in an array, as shown in FIG. 3, but not limited thereto, so as to achieve the purpose of vibration feedback relating to multi-touch as the above exemplary embodiment, and achieve the purpose of vibration/sound feedback with different levels, such that the detail descriptions thereto are also omitted.

In summary, the disclosure provides a touch pad with a feedback function, and the provided touch pad includes a combination of a vibration film layer and a touch sensing film layer which may: 1) share the ground layer and adopt the respective signal layers; 2) adopt the respective ground layers and the respective signal layers; or 3) share the ground layer and the signal layer. Accordingly, the provided touch pad is not only to be served as an input device/interface, and the user can easily confirm whether the inputs are successful or not by the generation of vibration and/or sound thereof.

In other words, any technical manner for implementing the vibration/sound feedback of the touch event(s) by equipping the permanent charge layer in the touch pad falls within the scope of the disclosure. In addition, due to the provided touch pad with the feedback function can simultaneously generate the vibration and sound feedback in response to the touch event(s), such that the applied touch pad thereof can be led into a new graduation application field, for example, blind, elderly, at inconvenient visible occasions, games, etc., even the provided touch pad with the feedback function can be suitable for any product with the touch function, for example, cell phone, tablet PC, eBook, computer, display, etc. The application field of the provided touch pad with the feedback function can be widely spread by collocating with the corresponding control software in the actual application.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A touch pad with a feedback function, comprising:
a touch sensing film layer; and
a vibration film layer, disposed with the touch sensing film layer and comprising a permanent charge layer, wherein the vibration film layer is configured for generating vibration in response to a touch event on the touch sensing film layer.

2. The touch pad with the feedback function according to claim 1, wherein the touch sensing film layer comprises:
a first electrode layer, disposed above a display module;
a first spacer layer, disposed above the first electrode layer; and
a common electrode layer, disposed above the first spacer layer,
wherein the first electrode layer and the common electrode layer form a touch sensing module so as to sense the touch event.

3. The touch pad with the feedback function according to claim 2, wherein the vibration film layer further comprises:
a second spacer layer, disposed above the common electrode layer and disposed under the permanent charge layer; and
a second electrode layer, disposed above the permanent charge layer,
wherein the second electrode layer and the common electrode layer coordinate with the permanent charge layer to generate the vibration in response to a driving signal generated by the touch event.

4. The touch pad with the feedback function according to claim 3, wherein the common electrode layer is a ground layer, and the first and the second electrode layers are signal layers.

5. The touch pad with the feedback function according to claim 4, wherein the second electrode layer and the common electrode layer further coordinate with the permanent charge layer to generate sound in response to the driving signal generated by the touch event.

6. The touch pad with the feedback function according to claim 4, wherein the second electrode layer has a plurality of patterned electrodes, and the patterned electrodes coordinate with the common electrode layer and the permanent charge layer to respectively generate different vibrations in response to a plurality of different driving signals generated by a plurality of different touch events on the touch sensing film layer.

7. The touch pad with the feedback function according to claim 6, wherein the patterned electrodes further coordinate with the common electrode layer and the permanent charge layer to respectively generate different sounds in response to the driving signals generated by the touch events.

8. The touch pad with the feedback function according to claim 3, further comprising:
a hard coat layer, disposed above the second electrode layer.

9. The touch pad with the feedback function according to claim 1, wherein the touch sensing film layer comprises:
a first electrode layer, disposed above a display module;
a first spacer layer, disposed above the first electrode layer; and
a second electrode layer, disposed above the first spacer layer,
wherein the first electrode layer and the second electrode layer form a touch sensing module so as to sense the touch event.

10. The touch pad with the feedback function according to claim 9, wherein the vibration film layer further comprising:
an isolation layer, disposed above the second electrode layer;
a third electrode layer, disposed above the isolation layer;
a second spacer layer, disposed above the third electrode layer and disposed under the permanent charge layer; and
a fourth electrode layer, disposed above the permanent charge layer,
wherein the third electrode layer and the fourth electrode layer coordinate with the permanent charge layer to generate the vibration in response to a driving signal generated by the touch event.

11. The touch pad with the feedback function according to claim 10, wherein one of the first and the second electrode layers and one of the third and the fourth electrode layers are ground layers, and the other of the first and the second electrode layers and the other of the third and the fourth electrode layers are signal layers.

12. The touch pad with the feedback function according to claim 11, wherein the third electrode layer and the fourth electrode layer further coordinate with the permanent charge layer to generate sound in response to the driving signal generated by the touch event.

13. The touch pad with the feedback function according to claim 11, wherein the third or the fourth electrode layer corresponding to the signal layer has a plurality of patterned electrodes, and the patterned electrodes coordinate with the third or the fourth electrode layer corresponding to the ground layer and the permanent charge layer to respectively generate different vibrations in response to a plurality of different driving signals generated by a plurality of different touch events on the touch sensing film layer.

14. The touch pad with the feedback function according to claim 13, wherein the patterned electrodes further coordinate with the third or the fourth electrode layer corresponding to the ground layer and the permanent charge layer to respectively generate different sounds in response to the driving signals generated by the touch events.

15. The touch pad with the feedback function according to claim 10, further comprising:
a hard coat layer, disposed above the fourth electrode layer.

16. The touch pad with the feedback function according to claim 1, wherein the touch sensing film layer is integrated with the vibration film layer to form a composite film layer, and the composite film layer comprises:
a first common electrode layer, disposed above a display module;
a common spacer layer, disposed above the first common electrode layer and disposed under the permanent charge layer; and
a second common electrode layer, disposed above the permanent charge layer,
wherein the first and the second common electrode layers form a touch sensing module to sense the touch event, and the first and the second common electrode layers further coordinate with the permanent charge layer to generate the vibration in response to a driving signal generated by the touch event.

17. The touch pad with the feedback function according to claim 16, wherein the first common electrode layer is one of a ground layer and a signal layer, and the second common electrode layer is the other one of the ground layer and the signal layer.

18. The touch pad with the feedback function according to claim 16, wherein the first and the second common electrode layers further coordinate with the permanent charge layer to generate sound in response to the driving signal generated by the touch event.

19. The touch pad with the feedback function according to claim 17, wherein in case that the first common electrode layer is the ground layer and the second common electrode layer is the signal layer, the second common electrode layer has a plurality of patterned electrodes, and the patterned electrodes coordinate with the first common electrode layer and the permanent charge layer to respectively generate different vibrations in response to a plurality of different driving signals generated by a plurality of different touch events on the touch sensing film layer.

20. The touch pad with the feedback function according to claim 19, wherein the patterned electrodes further coordinate with the first common electrode layer and the permanent charge layer to respectively generate different sounds in response to the driving signals generated by the touch events.

21. The touch pad with the feedback function according to claim 16, further comprising:
a hard coat layer, disposed above the second common electrode layer.

22. The touch pad with the feedback function according to claim 1, wherein a material of the permanent charge layer is an electret material.

23. A touch device, comprising:
a display module, configured to be served as a display interface of the touch device; and
a touch pad with a feedback function, comprising:
a touch sensing film layer, disposed above the display module, configured to be served as an input interface of the touch device; and
a vibration film layer, disposed above the touch sensing film layer and comprising a permanent charge layer, wherein the vibration film layer is configured for generating vibration in response to a touch event on the touch sensing film layer.

24. A vibration film layer, suitable for a touch pad, and the vibration film layer comprising:
a first electrode layer, disposed above a touch sensing film layer of the touch pad;
a spacer layer, disposed above the first electrode layer;
a permanent charge layer, disposed above the spacer layer; and
a second electrode layer, disposed above the permanent charge layer,
wherein the first and the second electrode layers coordinate with the permanent charge layer to generate vibration in response to a touch event on the touch sensing film layer.

25. The vibration film layer according to claim 24, wherein the first electrode layer is a ground layer, and the second electrode layer is a signal layer,
wherein the vibration film layer further comprises an isolation layer disposed between the first electrode layer and the touch sensing film layer,
wherein a material of the permanent charge layer is an electret material.
